(19) United States
(12) Patent Application Publication
(10) Pub. No.: US 2026/0099209 A1
(43) Pub. Date: Apr. 9, 2026

(54) WEARABLE ELECTROMYOGRAPHY SYSTEMS AND METHODS

(71) Applicant: Georgia Tech Research Corporation, Atlanta, GA (US)

(72) Inventor: Nathan Damen, Atlanta, GA (US)

(21) Appl. No.: 19/352,940

(22) Filed: Oct. 8, 2025

Related U.S. Application Data
(60) Provisional application No. 63/704,816, filed on Oct. 8, 2024.

(51) Int. Cl. G06F 3/01

(52) U.S. Cl. CPC G06F 3/017; G06F 3/011

(57) ABSTRACT

An example wearable device includes an electrode sensor array comprising a plurality of analog sensor units and configured to record analog measurements corresponding to a human hand motion; an analog-to-digital converter to convert the analog measurements to a plurality of digital measurements; a controller configured to record the plurality of digital measurements; a housing configured to enclose the controller and the analog-to-digital converter together, the housing coupled to the electrode sensor array; and a wearable band configured to affix the electrode sensor array and the housing to a wearer’s forearm, where the wearable band is configured to allow each analog sensor unit to be independently positioned relative to the housing.

### CROSS-REFERENCE TO RELATED APPLICATIONS

This application claims the benefit of U.S. provisional patent application No. 63/704,816, filed on October 8, 2024, and titled “BRAIN BRACER” the disclosure of which is expressly incorporated herein by reference in its entirety.

### BACKGROUND

Human input capabilities of the central nervous system are faster than the body's ability to output data as it interacts with the world. Brain-computer interfaces (BCI) provide a way to speed up the body’s ability to interact with external systems. One such BCI technology is surface electromyography (sEMG), a technique that measures the electrical signals produced by the motor-neurons.

While sEMG devices are a promising BCI, there are none that can withstand the wear and tear of daily use and provide enough resolution to accurately reconstruct human hand motion. Most custom sEMGs in academic research use thin, fragile PCB electrodes or single-use wet electrodes and lack a protective housing for the electronics, making them too delicate for real-world applications. Commercial sEMG devices lack the resolution of their academic counterparts, but have protective enclosures.

There would be, therefore, a benefit to developing improved brain-computer interfaces.

### SUMMARY

An exemplary system is disclosed that employs a rigid printed circuit board (PCB) and dry electrode surface electromyography platform for providing a user-computer interface using surface EMG signals of a user. The exemplary system includes a high-resolution electrode array and a lightweight artificial intelligence (AI) model in a portable wearable device to provide an accurate reconstruction of human hand motion. The system may be utilized for computer-assisted hand gesturing in high-noise environment (e.g., hand gestures between soldiers) or as a computer-interface. The exemplary system incorporates machine learning techniques to enable on-device compensation for electrode movement across the skin and/or to accurately identify which muscle’s EMG signal is being sensed. The electrode array are made of electrodes that are individually on a band that allows for adjustment of the electrodes to specific muscle groups, e.g., on the forearm. The system can measure the electrode readings and provide an output to the user when the electrodes are correctly positioned over the muscle.

In some aspects, implementations of the present disclosure include a system including: an electrode sensor array including a plurality of analog sensor units and configured to record a plurality of analog measurements corresponding to a human hand motion; an analog-to-digital converter to convert the plurality of analog measurements to a plurality of digital measurements; a controller configured to record the plurality of digital measurements; a housing configured to enclose the controller and the analog-to-digital converter together, the housing coupled to the electrode sensor array; and a wearable band configured to affix the electrode sensor array and the housing to a wearer's forearm, wherein the wearable band is configured to allow each analog sensor unit to be independently positioned relative to the housing.

In some aspects, implementations of the present disclosure include a system further including an electrode amplifier coupled to the electrode sensor array and configured to amplify the plurality of analog measurements.

In some aspects, implementations of the present disclosure include a system, wherein each analog sensor unit is configured to measure an analog measurement of the plurality of analog measurements.

In some aspects, implementations of the present disclosure include a system wherein the wearable band includes elastomers.

In some aspects, implementations of the present disclosure include a system, wherein the plurality of analog sensor units are configured to slide along the wearable band.

In some aspects, implementations of the present disclosure include a system, further including an inertial measurement unit configured to measure a position of the electrode sensor array or housing relative to a wearer's forearm.

In some aspects, implementations of the present disclosure include a system, wherein the controller is configured to classify the digital measurements as a gesture from a plurality of gestures.

In some aspects, implementations of the present disclosure include a system, wherein the controller is configured to classify the digital measurements by a lightweight machine learning model stored in a memory of the controller.

In some aspects, implementations of the present disclosure include a system, wherein the controller is operably coupled to a remote computing device configured to classify the digital measurements as a gesture from a plurality of gestures.

In some aspects, implementations of the present disclosure include a method including: receiving a plurality of analog measurements corresponding to a human hand gesture; converting the plurality of analog measurements to a plurality of digital measurements; determining, based on the plurality of analog measurements, the human hand gesture.

In some aspects, implementations of the present disclosure include a method, wherein determining the human hand gesture includes classifying the plurality of analog measurements as one of a plurality of human hand gestures.

In some aspects, implementations of the present disclosure include a method, wherein classifying the plurality of analog measurements includes inputting the plurality of analog measurements into a trained machine learning model.

In some aspects, implementations of the present disclosure include a method, wherein the trained machine learning model includes a lightweight classifier model.

In some aspects, implementations of the present disclosure include a method, wherein the plurality of analog measurements are recorded by a corresponding plurality of analog sensor units.

In some aspects, implementations of the present disclosure include a method, wherein the plurality of analog sensor units are individually positionable on a wearable band.

In some aspects, implementations of the present disclosure include a method including: receiving, by an electrode sensor array, a first plurality of analog measurements corresponding to a first human hand motion; determining, based on the first plurality of analog measurements, an estimated position of at least one analog sensor unit of the electrode sensor array relative to a wearer's forearm; outputting, by a controller, an instruction to reposition the analog sensor unit.

In some aspects, implementations of the present disclosure include a method, further including: receiving, by an inertial measurement unit, an estimated inertial position of the electrode sensor array, and wherein determining the estimated position of the at least one analog sensor unit is at least partially based on the estimated inertial position.

In some aspects, implementations of the present disclosure include a method, further including: receiving, by the electrode sensor array, a second plurality of analog measurements corresponding to a second human hand motion and determining, based on the second plurality of analog measurements, a second instruction to reposition the analog sensor unit.

In some aspects, implementations of the present disclosure include a method, wherein determining the estimated position of the at least one analog sensor unit is at least partially based on an amplitude of at least one of the plurality of analog measurements.

In some aspects, implementations of the present disclosure include a method, wherein the controller includes a display, and wherein outputting an instruction includes updating the display with an estimated position of the analog sensor array.

### BRIEF DESCRIPTION OF THE DRAWINGS

The skilled person in the art will understand that the drawings described below are for illustration purposes only.

FIG. 1 illustrates an example system including a wearable device configured to implement a user interface using electromyography, according to embodiments of the present disclosure.

FIG. 2 illustrates a perspective view of an example wearable device configured for electromyography, according to an embodiment of the present disclosure.

FIG. 3 illustrates a perspective view of an example wearable device and wearable band configured for electromyography, according to an embodiment of the present disclosure.

FIG. 4A illustrates a bottom-perspective view of an example wearable device configured for electromyography with two wearable bands, according to an embodiment of the present disclosure.

FIG. 4B illustrates a top-perspective view of the example wearable device shown in FIG. 4A.

FIG. 5 illustrates an example method of determining a human hand gesture using a wearable device to perform electromyography, according to embodiments of the present disclosure.

FIG. 6 illustrates an example method of positioning a wearable device to perform electromyography, according to embodiments of the present disclosure.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entirety and to the same extent as if each reference were individually incorporated by reference.

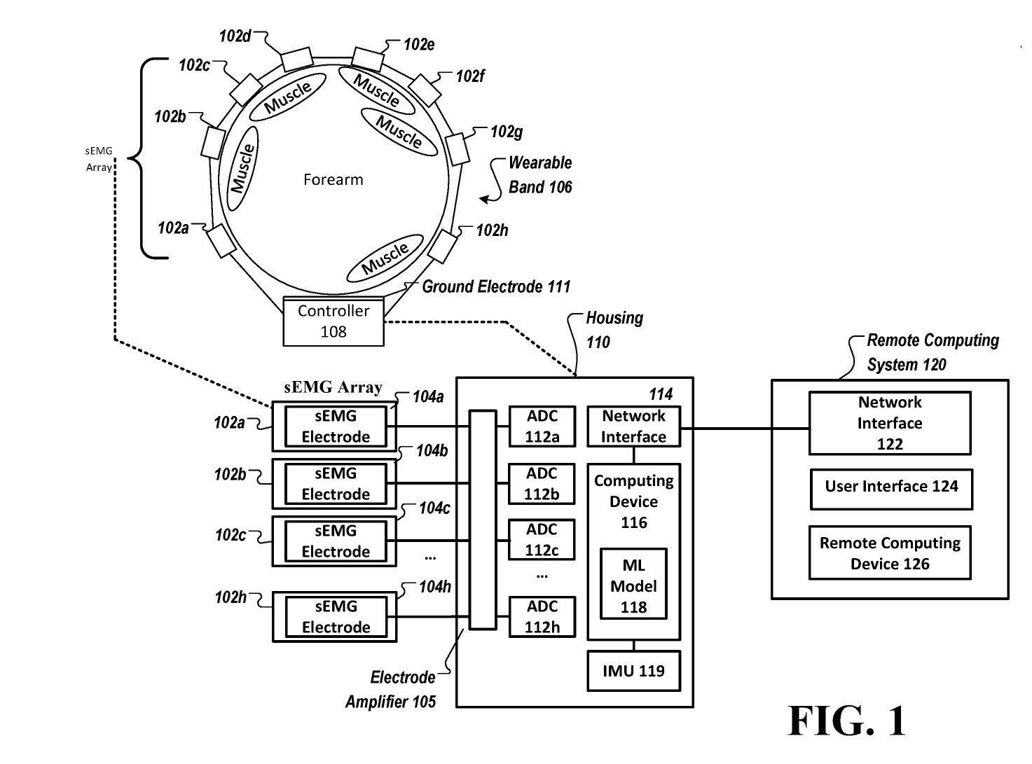

FIG. 1 illustrates an example embodiment of the present disclosure configured as a system for providing a user interface using a wearable surface electromyography (sEMG) device. While the system shown in FIG. 1 is pictured for measuring sEMG signals of a forearm, it should be understood that embodiments of the present disclosure can be worn on different parts of the body, including any limb or the torso, to measure sEMG signals from any muscle or combination of muscles.

The sEMG system includes an sEMG array of sEMG sensors 102a-102h. While 8 sEMG sensors 102a-102h are shown, it should be understood that this is only a non-limiting example and that any number of sEMG sensors can be used. It should also be understood that the relative position and spacing of the sEMG sensors 102a-102h can be varied in different embodiments of the present disclosure.

Each sEMG sensor 102a-102h can include one or more sEMG electrodes 104a-104h. In the example shown in FIG. 1, each sEMG sensor 102a-102h includes a single sEMG electrode 104a-104h, but optionally each sEMG sensor 102a-102h can include a pair of sEMG electrodes 104a-104h, or more than two sEMG electrodes 104a-104h. The sEMG sensors 102a-102h can be coupled together using a wearable band 106. The wearable band 106 can be configured so that each sEMG sensor 102a-102h can be individually positioned along the wearable band 106, so that the relative positions of the sEMG sensors 102a-102h can be adjusted to optimize the sEMG signals received. The wearable band 106 can optionally terminate at a controller 108. The controller 108 can be coupled to the sEMG sensors 102a-102h through wired or wireless connections to receive sEMG signals from the sEMG sensors 102a-102h. Optionally, each sEMG sensor 102a-102h can include an ADC, microcontroller and/or network interface enabling sEMG signals to be digitized and/or wirelessly transmitted to the controller 108.

The controller 108 can include a housing 110 that acts as an anchor for the wearable band 106 and can partially or completely surround signal processing circuitry. For example, the controller 108 can include an electrode amplifier 105 configured to amplify analog sEMG signals from the sEMG electrodes 104a-104h. Optionally, the electrode amplifier 105 can be a low-noise instrumentation amplifier. Alternatively or additionally, more than one electrode amplifier 105 can be used in series or parallel (e.g., as a multi-stage amplifier). The controller 108 can optionally include a ground electrode 111 that is disposed on the skin to serve as a reference plane for the other sensor electrode measurements.

The controller 108 can further include one or more analog-to-digital converters (ADCs) shown as ADCs 112a-112h. The ADCs 112a-112h can be coupled to an electrode amplifier 105 or directly to the sEMG electrodes 104a-104h. The ADCs 112a-112h are configured to convert analog sEMG signals to digital sEMG signals. The ADCs 112a-112h can be operably coupled to a computing device 116 in the controller 108 that can be configured to record the sEMG signals. Optionally, the ADCs 112a-112h can be incorporated into the computing device 116 (e.g., as integrated ADC inputs to a microcontroller).

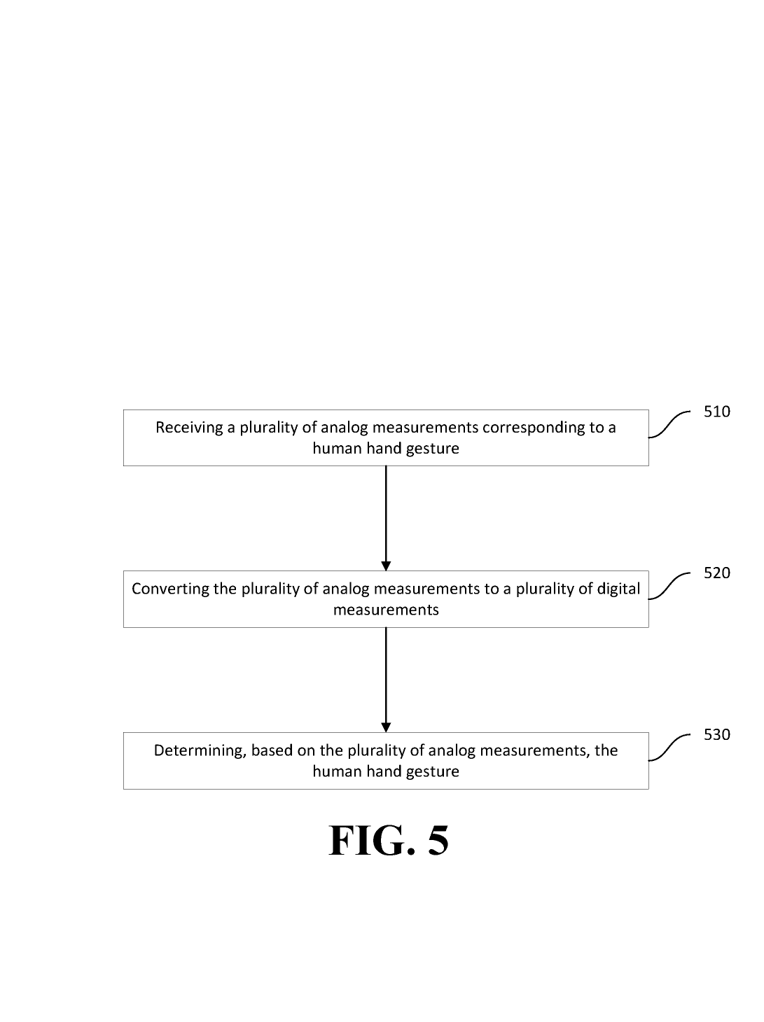

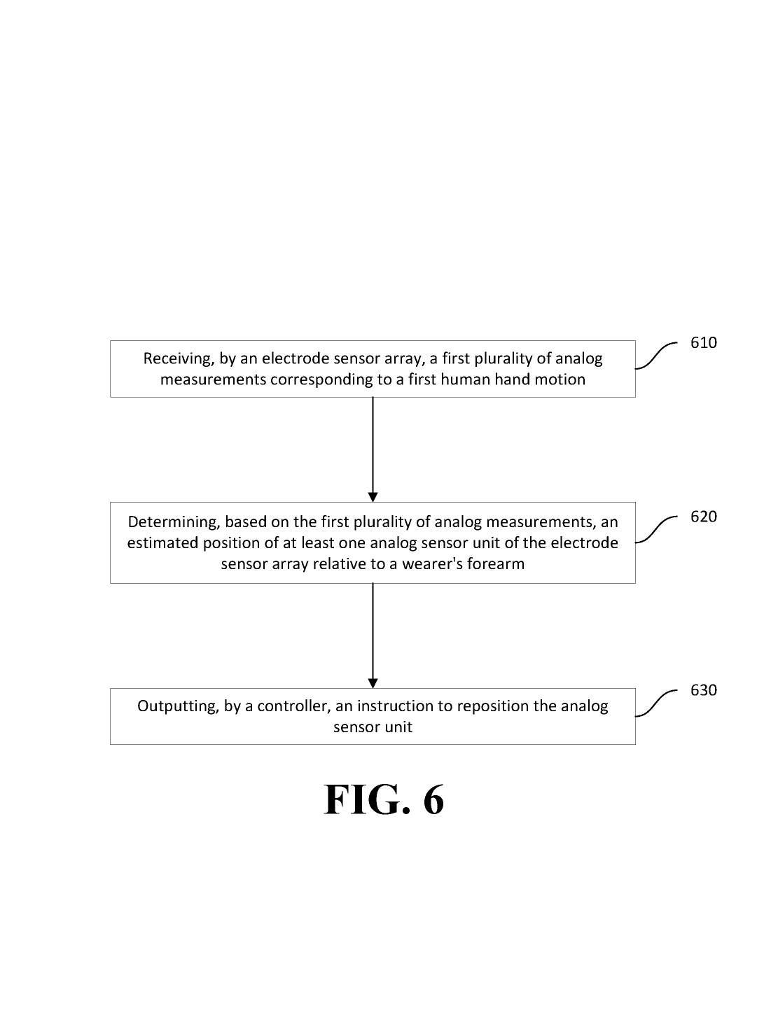

Optionally, the computing device 116 can be configured to perform the methods described herein (e.g., the methods of FIG. 5 and FIG. 6). For example, the computing device 116 can optionally include a lightweight machine learning model 118 (e.g., a lightweight classifier model) configured to process the recorded sEMG signals and classify a gesture and/or muscle movement based on the sEMG signals.

The controller 108 can further include an inertial measurement unit 119 that can be operably coupled to the computing device 116 and configured to measure an orientation, or acceleration of the controller 108, or to estimate a position of the controller 108. The position, orientation, and/or acceleration of the controller 108 can be used to calibrate the sEMG signals or as additional inputs used to classify the gesture or muscle movement.

The controller 108 can further include a network interface 114 (e.g., Bluetooth, Wi-Fi, ultra-wideband, etc.). The network interface 114 can be in communication with a remote computing system 120 through a second network interface 122 of the remote computing system 120.

Embodiments of the present disclosure can be used to implement user interfaces and to control remote computing systems 120 using sEMG signals recorded by the controller 108. Examples of user interfaces 124 include moving a mouse cursor on a GUI computer, accessing a GUI of any computing device by selecting or deselecting elements, and controlling a virtual environment (e.g., augmented or virtual reality). The remote computing system 120 can include one or more remote computing devices 126 (e.g., computers, servers, smartphones etc.) that are configured to provide the user interface 124, process commands based on the sEMG signals, and update a display of the user interface 124 based on the commands.

An example system includes physical hardware including a rigid PCB, dry electrodes, and modular design using rapid prototyping. The modular design allows for each sensor to be disconnected, replaced, and the system to be repaired in field.

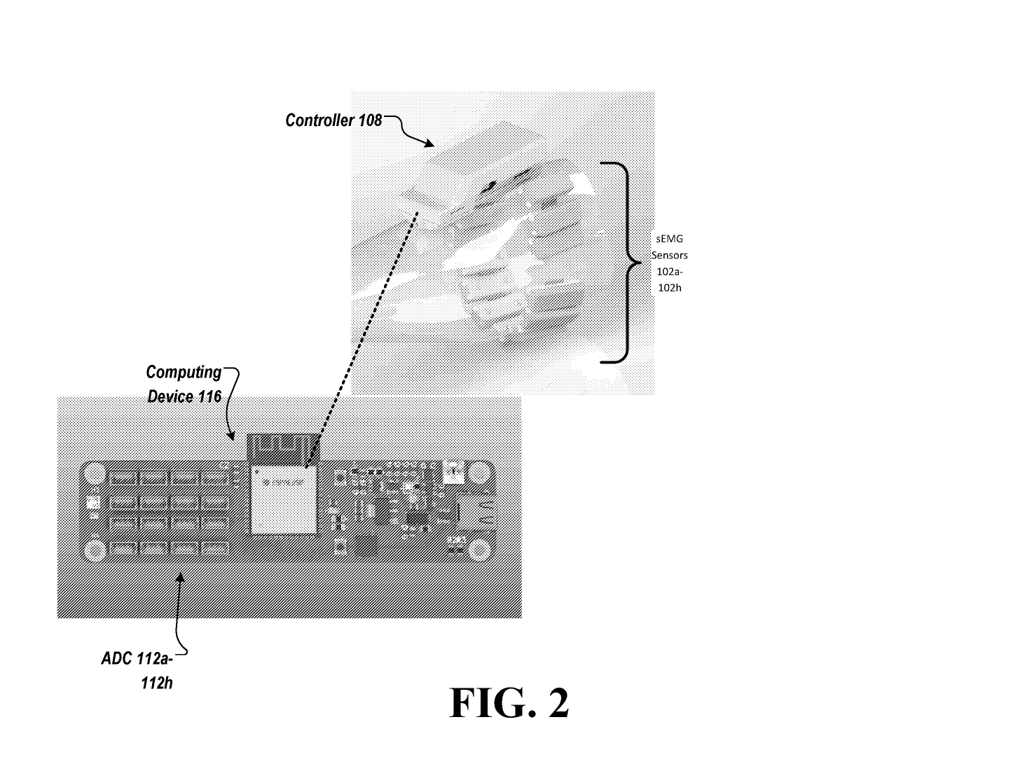

The example modular design includes an electrode sensor board, a board to gather all analog signals and convert them to digital signals, and a main microcontroller board. With these boards fabricated, a mechanical housing for the system was designed stacking the main board and analog to digital board (ADC) to form a controller 108 as shown in FIG. 2. The controller 108 can include the computing device 116 and ADCs 112a-112h described with reference to FIG. 1. Optionally, the controller 108 can be formed in a stacked configuration using multiple layers of PCBs, where different elements of the controller 108 are formed on different PCBs.

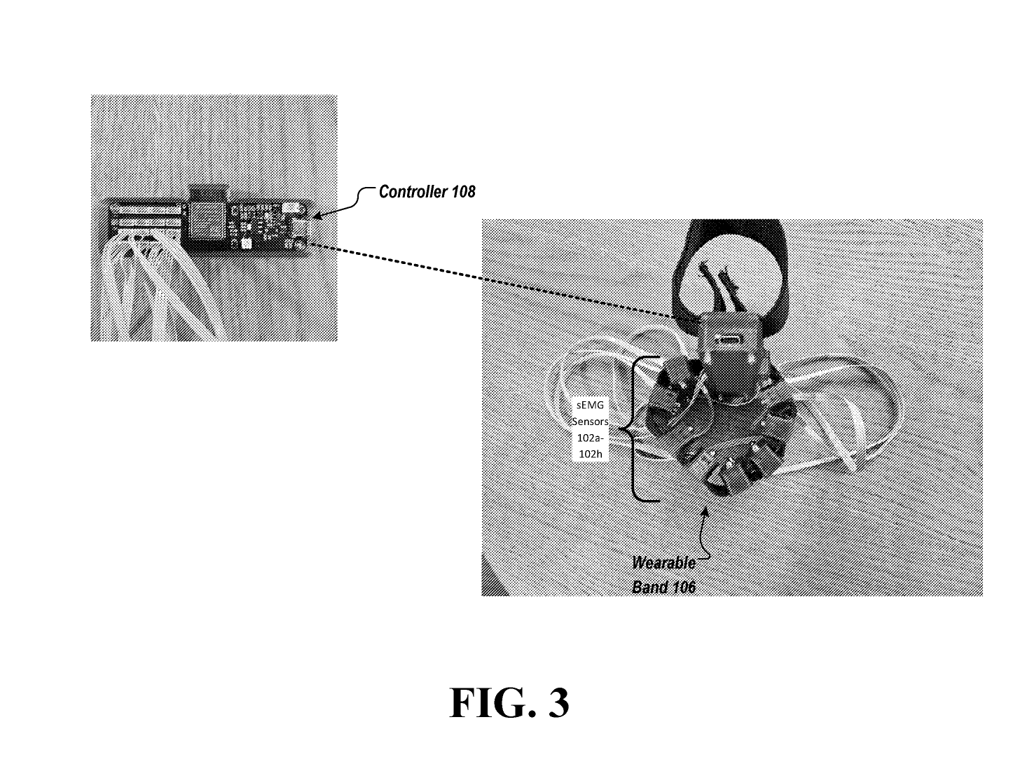

FIG. 3 illustrates an example embodiment of the present disclosure based on the design of FIG. 2. The controller 108 can be coupled to a wearable band 106 that couples each of the sEMG sensors 102a-102h together. The wearable band 106 can optionally be formed by an elastomer or other elastic material. Optionally, the wearable band 106 can be adjustable by pulling (e.g., toward or away from) the controller 108 where the wearable band 106 is attached. The wearable band 106 can enable each of the sEMG sensors 102a-102h to contact the body in any orientation. The controller 108 can obtain all the analog signals from the sEMG sensors 102a-102h and read them directly. It should be understood that in some embodiments the ADCs 112a-112h can be part of a computing device 116 (e.g., as a single integrated circuit) and in other embodiments, the ADCs 112a-112h can be one or more discrete circuits coupled to a computing device (e.g., with or without multiplexers).

In the example embodiment, the final chipsets selected for the main components were as follows: ESP32-S3 for the microcontroller and INA828 for the electrode amplifiers. The gain on the sEMG sensor boards was 251 times the original signal. All housings were 3D-printed with PETG. It should be understood that the selection of particular circuits, amplification amounts, and materials herein are intended only as non-limiting examples.

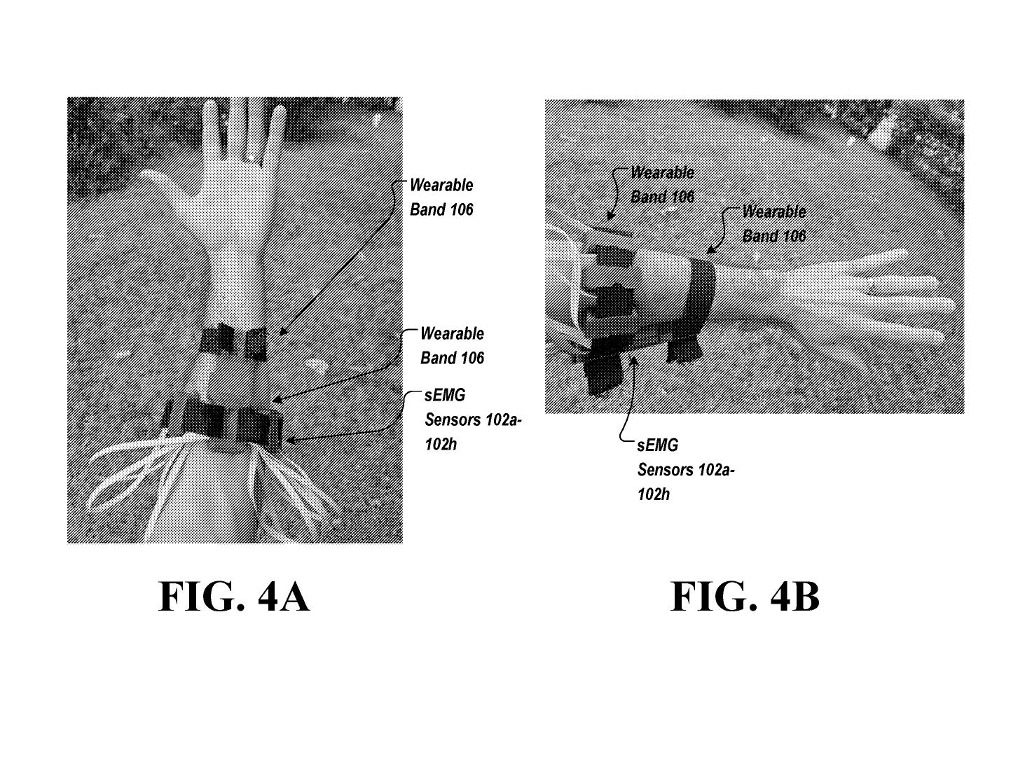

FIGS. 4A and 4B illustrate a bottom perspective view and a top perspective view of an example device according to implementations of the present disclosure. The device includes sEMG sensors 102a-102h disposed on wearable bands 106.

With reference to FIGS. 5 and 6, embodiments of the present disclosure include methods that can be performed using the systems and devices described herein.

With reference to FIG. 5, a method of determining a hand gesture using sEMG signals is shown. The method of FIG. 5 can optionally be performed using the systems and devices of FIGS. 1-4. For example, different hand gestures can cause different user inputs to be selected in a GUI or other interface.

At step 510, the method includes receiving analog measurements corresponding to a human hand gesture.

At step 520, the method includes converting the analog measurements to a plurality of digital measurements.

At step 530, the method includes determining, based on the digital measurements, the human hand gesture. Optionally, step 530 can be performed by inputting digital measurements into a trained machine learning model. Optionally, the machine learning model is a lightweight trained machine learning model. The lightweight trained machine learning model can be configured to classify the analog measurements as one of a set of human hand gestures and output the human hand gesture that the analog measurements correspond to.

With reference to FIG. 6, a method of positioning a wearable device is shown. The method of FIG. 6 can be used to position the sEMG sensors 102a-102h described in FIG. 1 in an optimized configuration for receiving sEMG signals.

At step 610, the method includes receiving, by an electrode sensor array, a first plurality of analog measurements corresponding to a first human hand motion. The analog measurements can be processed to determine which analog measurements correspond to respective sEMG signals from different muscles in the hand or arm. Because sEMG signals become attenuated as the sensor is farther from the muscle, the distance of each sensor from each muscle can be estimated from the sEMG signals. Thus, the position of each electrode sensor of the electrode sensor array can be estimated relative to the muscles in the hand or arm by using the amplitude of the sEMG signals.

At step 620, the method includes determining, based on the first plurality of analog measurements, an estimated position of at least one analog sensor unit (e.g., any of the sEMG sensors 102a-102h described herein) of the electrode sensor array relative to a wearer’s forearm;

At step 630, the method includes outputting, by a controller, an instruction to reposition the analog sensor unit. Optionally, the instruction can be output by a controller with a a display (e.g., audio or visual display) and the display can be iteratively or continuously updated as the user moves the analog sensor unit (e.g., the controller 108, wearable band 106, and/or sEMG array described in FIG. 1). Optionally, the user can move individual sEMG sensors 102a-102h of the array relative to each other along the wearable band 106. The method of FIG. 6 can be repeated until each sEMG electrode 104a-104h is in an optimized position for sEMG sensing.

Optionally, the method of FIG. 6 can further includer receiving, by an inertial measurement unit, an estimated inertial position of the electrode sensor array. The position of the electrode sensor array can be used to determine the position of the individual sensors of the electrode senor array, or the overall position or orientation of the electrode sensor array as a whole.

Alternatively or additionally, the method can further include receiving, by the electrode sensor array, a second plurality of analog measurements corresponding to a second human hand motion and determining, based on the second plurality of analog measurements, a second instruction to reposition the analog sensor unit.

### Discussion

Humans are fast at ingesting data, and slower at generating output signals. Brain-computer interfaces (BCIs) are needed to address this mismatch in input/output speeds, enabling faster user interactions through computing systems and robotic augmentations. Therefore, improvements to non-invasive BCIs, like the surface electromyography (sEMG) devices described herein, can be a useful solution to existing limitations of such systems. The present disclosure addresses the gap between technology in the lab and daily wearable hardware. Conventional research sEMG devices are not designed for sustained daily use due to their fragile, flexible PCB electrodes, and single-use wet electrodes [2] [4]. Commercially available sEMGs lack the resolution to detect the signals necessary for reconstructing all human hand gestures [1] [3] [7].

The example implementations of the present disclosure shown in FIGS. 2-4B were designed and tested. The example implementations include modular sEMG bracelets that can be used for user interfaces, as well as to train humans to activate small clusters of motor neurons. Small cluster motor-neuron activation may not result in visible motion but may be sensed with the systems described herein. An artificial intelligence (AI) algorithm can be integrated into the exemplary system to learn what motor neurons a person may activate. The AI algorithm can then map the detected pattern to a common computing interface, creating a unique language for that individual to interact with different computing systems. Enabling computing based on small clusters of motor neurons can enable thought-based computing, where thoughts of motor activity are used to control user interfaces, without visible body movements.

### Conclusion

It must also be noted that, as used in the specification and the appended claims, the singular forms “a,” “an,” and “the” include plural referents unless the context clearly dictates otherwise. Ranges may be expressed herein as from “about” or “approximately” one particular value and/or to “about” or “approximately” another particular value. When such a range is expressed, other exemplary embodiments include one particular value and/or the other particular value.

By “comprising” or “containing” or “including,” is meant that at least the name compound, element, particle, or method step is present in the composition or article or method but does not exclude the presence of other compounds, materials, particles, method steps, even if the other such compounds, material, particles, method steps have the same function as what is named.

In describing example embodiments, terminology is used for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The following patents, applications and publications as listed below and throughout this document are hereby incorporated by reference in their entirety herein.

[1] M. Paleari, M. Di Girolamo, N. Celadon, A. Favetto and P. Ariano, "On optimal electrode configuration to estimate hand movements from forearm surface electromyography," 201537th Annual International Conference of the IEEE Engineering in Medicine and Biology Society (EMBC), Milan, Italy, 2015, pp. 6086-6089, doi: 10.1109/EMBC.2015.7319780.

[2] Rossi F, Motto Ros P, Rosales RM, Demarchi D. Embedded Bio-Mimetic System for Functional Electrical Stimulation Controlled by Event-Driven sEMG. Sensors (Basel). 2020 Mar 10;20(5):1535. doi: 10.3390/s20051535. PMID: 32164356; PMCID: PMC7085782.

[3] Romero Avila E, Junker E, Disselhorst-Klug C. Introduction of a sEMG Sensor System for Autonomous Use by Inexperienced Users. Sensors (Basel). 2020 Dec 21;20(24):7348. doi: 10.3390/s20247348. PMID: 33371409; PMCID: PMC7767446.

[4] Moin, A., Zhou, A., Rahimi, A. et al. A wearable biosensing system with in-sensor adaptive machine learning for hand gesture recognition. Nat Electron 4, 54–63 (2021). https://doi.org/10.1038/s41928-020-00510-8

[5] Yang Z, Jiang D, Sun Y, Tao B, Tong X, Jiang G, Xu M, Yun J, Liu Y, Chen B, Kong J. Dynamic Gesture Recognition Using Surface EMG Signals Based on Multi-Stream Residual Network. Front Bioeng Biotechnol. 2021 Oct 22;9:779353. doi: 10.3389/fbioe.2021.779353. PMID: 34746114; PMCID: PMC8569623

[6] R. Merletti, G.L. Cerone, Tutorial. Surface EMG detection, conditioning and pre-processing: Best practices, Journal of Electromyography and Kinesiology, 2020, 102440, ISSN 1050-6411, https://doi.org/10.1016/j.jelekin.2020.102440.

[7] Tatarian, Karen & Couceiro, Micael & Ribeiro, Eduardo & Faria, Diego. (2018). Stepping-stones to Transhumanism: An EMG-controlled Low-cost Prosthetic Hand for Academia. 10.1109/IS.2018.8710489.

What is claimed:

1. A system comprising:
an electrode sensor array comprising a plurality of analog sensor units and configured to record a plurality of analog measurements corresponding to a human hand motion;
an analog-to-digital converter to convert the plurality of analog measurements to a plurality of digital measurements;
a controller configured to record the plurality of digital measurements;
a housing configured to enclose the controller and the analog-to-digital converter together, the housing coupled to the electrode sensor array; and
a wearable band configured to affix the electrode sensor array and the housing to a wearer’s forearm, wherein the wearable band is configured to allow each analog sensor unit to be independently positioned relative to the housing.

2. The system of claim 1, further comprising an electrode amplifier coupled to the electrode sensor array and configured to amplify the plurality of analog measurements.

3. The system of claim 1, wherein each analog sensor unit is configured to measure an analog measurement of the plurality of analog measurements.

4. The system of claim 1, wherein the wearable band comprises elastomers.

5. The system of claim 3, wherein the plurality of analog sensor units are configured to slide along the wearable band.

6. The system of claim 1, further comprising an inertial measurement unit configured to measure a position of the electrode sensor array or housing relative to a wearer’s forearm.

7. The system of claim 1, wherein the controller is configured to classify the digital measurements as a gesture from a plurality of gestures.

8. The system of claim 1, wherein the controller is configured to classify the digital measurements by a lightweight machine learning model stored in a memory of the controller.

9. The system of claim 1, wherein the controller is operably coupled to a remote computing device configured to classify the digital measurements as a gesture from a plurality of gestures.

10. A method comprising:
receiving a plurality of analog measurements corresponding to a human hand gesture;
converting the plurality of analog measurements to a plurality of digital measurements;
determining, based on the plurality of analog measurements, the human hand gesture.

11. The method of claim 10, wherein determining the human hand gesture comprises classifying the plurality of analog measurements as one of a plurality of human hand gestures.

12. The method of claim 11, wherein classifying the plurality of analog measurements comprises inputting the plurality of analog measurements into a trained machine learning model.

13. The method of claim 12, wherein the trained machine learning model comprises a lightweight classifier model.

14. The method of claim 10, wherein the plurality of analog measurements are recorded by a corresponding plurality of analog sensor units.

15. The method of claim 14, wherein the plurality of analog sensor units are individually positionable on a wearable band.

16. A method comprising:
receiving, by an electrode sensor array, a first plurality of analog measurements corresponding to a first human hand motion;
determining, based on the first plurality of analog measurements, an estimated position of at least one analog sensor unit of the electrode sensor array relative to a wearer’s forearm; and
outputting, by a controller, an instruction to reposition the analog sensor unit.

17. The method of claim 16, further comprising: receiving, by an inertial measurement unit, an estimated inertial position of the electrode sensor array, and wherein determining the estimated position of the at least one analog sensor unit is at least partially based on the estimated inertial position.

18. The method of claim 16, further comprising: receiving, by the electrode sensor array, a second plurality of analog measurements corresponding to a second human hand motion and determining, based on the second plurality of analog measurements, a second instruction to reposition the analog sensor unit.

19. The method of claim 16, wherein determining the estimated position of the at least one analog sensor unit is at least partially based on an amplitude of at least one of the plurality of analog measurements.

20. The method of claim 16, wherein the controller comprises a display, and wherein outputting an instruction comprises updating the display with an estimated position of the analog sensor array.
